(19) United States
(12) Patent Application Publication
(10) Pub. No.: US 2011/0055006 A1
(43) Pub. Date: Mar. 3, 2011

(54) Advertising Distribution System

(75) Inventor: James D. HICKMAN, Nelson (CA)

(73) Assignee: ADS GLOBAL MEDIA SYSTEMS CORPORATION, Nelson (CA)

(21) Appl. No.: 12/852,507

(22) Filed: Aug. 8, 2010

Related U.S. Application Data
(63) Continuation of application No. 12/740,335.
Application No. 12/740,335 is a continuation-in-part of application No. PCT/CA2008/001892, filed on Oct. 29, 2008.

(51) Int. Cl. G06Q 30/00

(52) U.S. Cl. 705/14.48; 705/14.73; 705/14.69

(57) ABSTRACT

The invention is a software system capable of managing advertisement campaigns across remote digital signage advertising participating locations. The system provides interfaces for advertisers, locations, system administrators and consumers. Central to the system is an algorithm that ensures advertising budgets are dispersed across a specified timeframe. This algorithm adapts to changes in campaign timeframes, price per advertisement impression, number of active locations, average display frequency per location and addition, revision or removal of advertisements.

### TECHNICAL FIELD

The present invention relates to advertising. In particular, the present invention relates to a system for distributed electronic advertising.

### BACKGROUND OF THE INVENTION

The use of digital signage in advertising has been evolving increasingly rapidly in recent years. This growth may be attributed to the ease of operation, lower equipment costs and the ability to own and operate a digital signage business without prior experience. In the digital media industries, this “anyone can do it” approach results in a lack of commonality, continuity or communal access to digital media systems. Digital signage management systems have been developed to distribute digital media within a closed system. However, there is at present no system to connect a variety of advertisers to a plurality of demographically categorized digital signage locations or networks.

To date, the only way an advertiser can access the digital signage market is by locating networks and making individual purchases. An advertiser is unable to buy advertising ‘en masse’. The majority of digital signage networks are too small to attract any major advertisers, and rely instead on local ad sales. Content must be developed for each company respecting all the different formats of delivery.

The present invention describes a solution to this problem.

### SUMMARY OF THE INVENTION

The present invention answers the question: “How can small networks gain access to national or international advertisers, and how can national or international advertisers gain access to existing digital signage advertising networks?

There is provided a digital advertising network for the distribution of multimedia advertisements, comprising a server; at least one administrator interface connected by a WAN to the server; at least one location interface connected by a WAN to the server and to each of the at least one administrator interfaces; and at least one advertiser interface connected by a WAN to the server, to each of the at least one administrator interfaces and to each of the at least one location interfaces.

The server may further comprise a mainframe computer having a storage component for storage of system data.

Each administrator interface may comprise commission management means managing location commissions; billing management means for managing advertiser billings; credit application management means for processing advertiser credit requests; and system reporting means for generating system reports.

Each location interface may comprise playlist management means for managing advertising playlists; earning reporting means for reporting location earnings; and settings means for setting location parameters.

Each advertiser interface may comprise campaign management means for managing advertising campaigns; advertising management means for managing advertisements; billing means for processing billings; credit application means for preparing credit applications; and reporting means for generating advertiser reports.

There is further provided a method of distributing advertisements in a digital advertising network, the method comprising the steps of a) identifying location demographic parameters for a plurality of locations; b) identifying a digital advertising campaign budget; c) identifying a digital advertising timeframe; d) identifying the campaign demographic parameters of the digital advertising campaign; e) selecting advertisements which are consistent with the campaign demographic parameters; f) identifying available locations by matching location demographic parameters to campaign demographic parameters; g) generating a distribution schedule which is consistent with the campaign budget, campaign timeframe and available locations; and h) distributing the digital advertising advertisements to the locations according to the distribution schedule.

The method may further comprise the additional steps after step (h) of (i) modifying the location demographic parameters; and (j) repeating steps (e) through (h).

The method may further comprise the additional steps after step (h) of (k) modifying the digital advertising campaign budget; and (l) repeating steps (g) and (h).

The method may further comprise the additional steps after step (h) of (m) modifying the digital advertising campaign budget; and (n) repeating steps (g) and (h).

The method may further comprise the additional steps after step (h) of (o) modifying the selection of advertisements; and (p) repeating steps (g) and (h).

### BRIEF DESCRIPTION OF THE DRAWINGS

A detailed description of the preferred embodiments is provided by way of example only and with reference to the following drawings, in which:

FIG. 1 is a schematic of the overall distributed advertising system of the present invention;

FIG. 2 is a schematic of the data input flow of the system;

FIG. 3 is a schematic of the advertiser interface component of the system;

FIG. 4 is a schematic of the location interface component of the system;

FIG. 5 schematic of the administrator interface component of the system; and

FIG. 6 is a schematic of the consumer interface component of the system.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

According to one embodiment of the present invention, there is provided a software system capable of managing advertisement campaigns across participating remote digital signage advertising locations. The system provides interfaces for advertisers, locations and administrators. Central to the system is an algorithm that ensures advertising budgets are allocated in a selected manner during a specified timeframe. This algorithm may be adapted to changes in campaign timeframes, price per advertisement impression, number of active locations, average display frequency per location and addition, revision or removal of advertisements.

The present invention connects advertisers to various digital signage locations which wish to display strategically selected advertisements. The system enables both the advertisers and these signage locations to automatically adjust advertising playlists based on a variety of actively monitored factors.

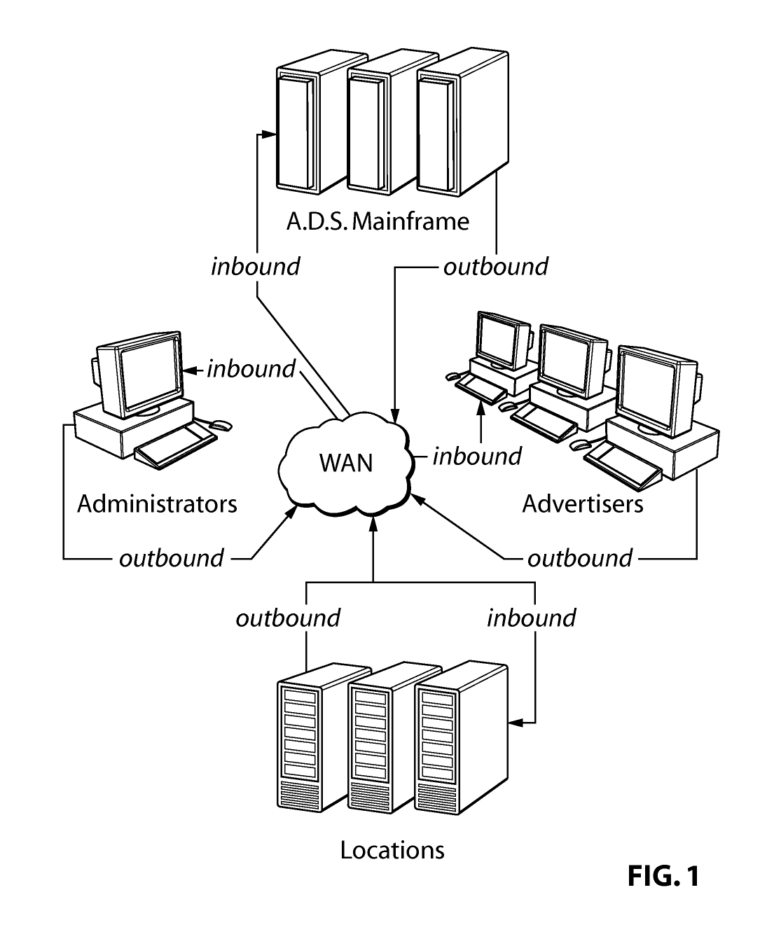

As depicted in FIG. 1, a mainframe [1002] may be hosted on computer servers accessible via the Internet or other wide area network (“WAN”) [1001]. Other components of the system of the present invention include the administrators [1003], advertisers [1004], and the locations [1005]. Each of the components may communicate with each other component via an Internet or other WAN connection, either wired or wireless.

The mainframe server is the control centre for all incoming and outgoing information. It is the access point for the advertisers as well as the locations. Advertisements may be uploaded and downloaded according to matches made from demographic profiles. The software may generate an invoice to be paid to the location based on the number of exposures and the rate paid per exposure. Another invoice may be generated for the advertiser for the total number of exposures registered by all the digital signs on a network.

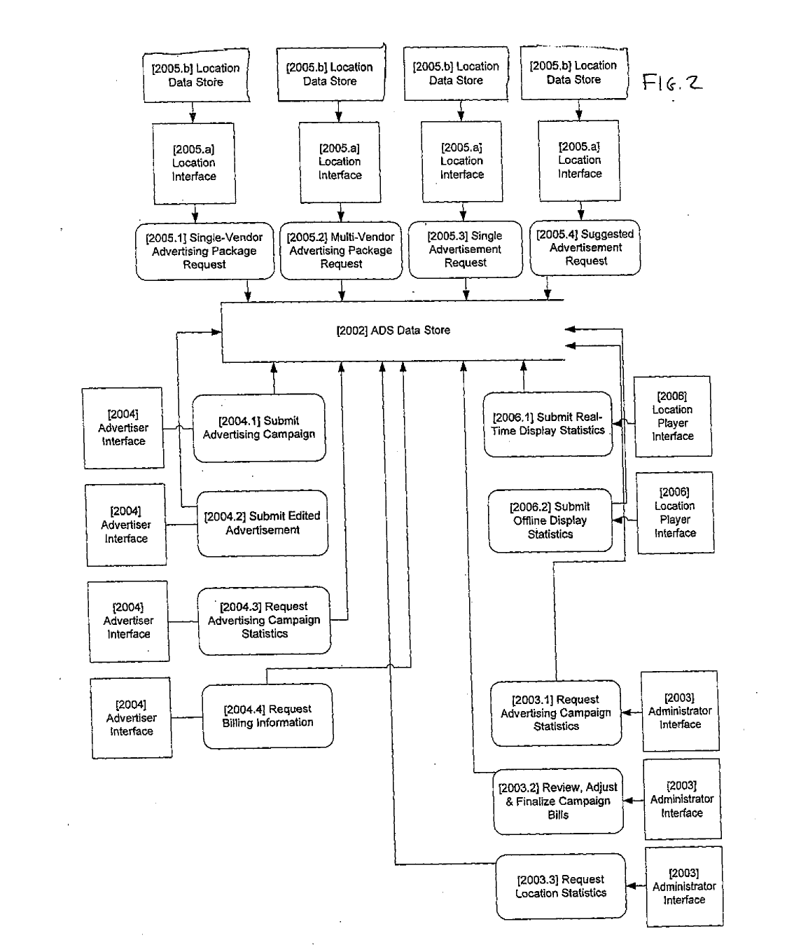

As shown in FIG. 2, advertisers can manage advertising campaigns through a software interface that remotely accesses the system mainframe. They can configure details of their campaigns, including budgets, timeframes and target demographics for each advertisement.

Locations, for example retail outlets or sports facilities, may manage an advertisement rotation or playlist from their digital signage location through a software interface that remotely accesses the system mainframe. Advertisements available to a location may be filtered based on algorithms which may calculate the need to increase or decrease display frequency and may suggest advertisements on the basis of their demographic compatibility with consumers at the location. Locations can configure playlists designed to increase retail sales revenues or to increase compensation earned through the display of advertisements at the location.

Administrators may access the system remotely through a software interface to the system mainframe. The administrator may generate a variety of reports, including reports in relation to one or more advertising campaigns of one or more advertisers or reports in relation to the display activity for one or more locations. The administrator may review, edit and confirm data, including campaign billing and commission payment data.

In the particularly advantageous embodiment of the software system outlined herein, a variety of advertisers may place their advertisements in a library of advertisements accessible by a vast group of digital signage advertising locations. Each location may select advertisements using determinants which reflect that location's strategic marketing goals. Advertisements may be filtered to restrict access by a particular location to advertisements which do not fit the demographic profile of that location.

As the location selects advertisements, a control algorithm may be applied to ensure that the selected advertisements are compatible with the budgetary limits and timeline as defined for each campaign. The present system adaptively displays advertisements not just for demographic fit but also to mete out advertisements faster or slower depending on the budget and schedule parameters. For example, an advertiser who wants their $1000 budget to extend over 4 weeks will have their ad displayed at a rate that is adjusted in real-time to exhaust the budget as near to the target of 4 weeks as possible.

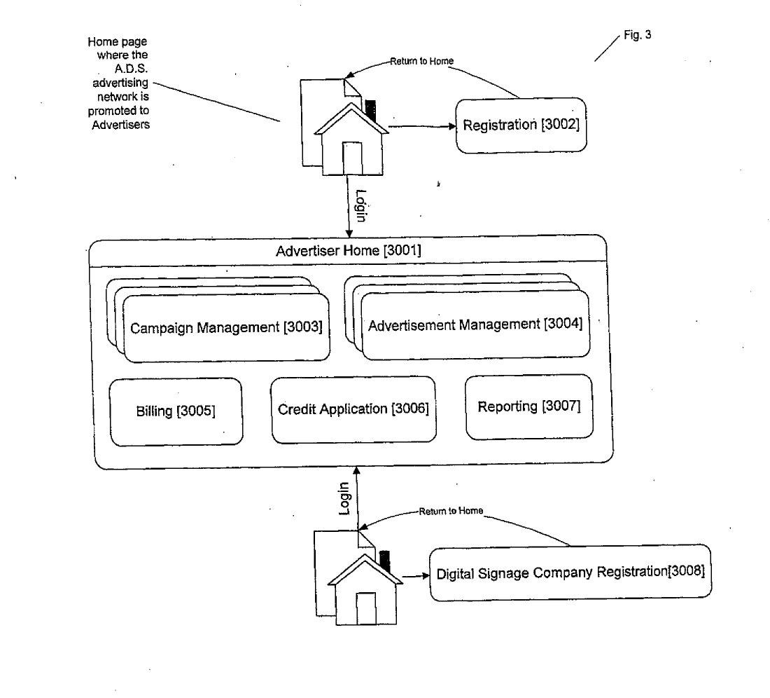

As set out schematically in FIG. 3, the advertising distribution system of the present invention comprises an advertiser management console. An advertiser may complete an online application form available from the system operator through its website, email distribution, or other venue. Upon creation of an advertiser account, immediate access may be granted to the advertiser management console to enable participation in the advertising network system of the present invention.

The console may be used for a variety of purposes. It may be used by advertisers to manage their accounts with the system operator. For example, advertiser clients may use the advertiser management console to arrange credit with the system operator, or to indicate that the advertising client will arrange payment manually through the accounting department of the system operator. Upon granting of credit, the advertiser is entitled to run advertisements through the system up to the threshold of the credit limit.

Another function of the advertising management console is the advertising campaign management component. The system of the invention may be used to create campaigns containing one or more advertisements. Each campaign may place advertisements into the advertisement pool to be accessed by one or more locations that meet the criteria necessary to view and display the advertisement. These criteria may be set through matching of demographic targeting options specified by the advertiser during the campaign creation stage and defined by each location. A particular location may have several demographic targets. For example, morning consumers may comprise a different demographic target than evening consumers.

The advertising management console may also include a process which allows advertisements in active campaigns to be edited or replaced to enable locations currently running the advertisement to automatically switch the old advertisement to the newly created or edited advertisement.

The advertising management console will also include an advertisement library. The library will store demographic information for each location, and brand and product information. The categorization details allow each location to choose advertisements designed to promote specific brands or products, to liquidate specific stock or simply to increase retail revenue. Demographic details restrict access only to those locations with an appropriate audience for the advertisement to be included in a playlist for that location.

The system will also permit storage of advertisement media on the server to enable locations to download advertisement content locally for rapid playback in an online or offline environment. The storage function will also permit active and archived storage of advertisements to allow advertisements to be made inactive but easily reusable in future campaigns.

The system will permit selective pricing of advertisements to encourage the display of specific advertisements or to increase profitability and reduce dilution on more popular advertisements. In the public access model the system incorporates a billing and payout system that automatically determines money owed by the advertisers and payout commissions for the locations displaying the advertisements. Advertisers set payout rates on their advertisements and locations are paid a percentage of those payouts. In the private network the user may manage billing advertisers and rewarding locations according to their own rules.

The system allows for separately managed public libraries designed to target different target audiences while allowing all data and software to be deployed and scaled as a single entity. This allows for rapid expansion into other target audiences including golfing, fast food restaurants, home electronics, and others simply by providing different entry points into the same system.

Each campaign added to the system is designed to display one or more advertisements for a prescribed period of time, at various commissions per impression across a number of participating locations that meet the campaign's demographic requirements. An averaging algorithm may be employed comprising a series of calculations that enforce the campaign's adherence to a specified time schedule and budget. The algorithm achieves this by accounting for changes to playlists, advertisements and campaigns by analyzing real-time data then adjusting locations and playlists to limit the frequency of display in order to comply with the campaign targets.

The algorithm employs a learning logic that incorporates adjustments based on analysis of historic data. The averaging algorithm ensures that appropriate demographics are targeted by accounting for the campaign and advertisement settings configured by both advertisers and locations.

Detailed campaign, advertisement and billing reports may be accessed online and may provide a concise breakdown of a campaign's adherence to the specified budget, schedule and demographic target. An export system and a statistics download system are included which consider the playback history of advertisements across all locations. Reports can be generated both for active and completed campaigns.

According to one embodiment of the present invention, users may create their own private sub-network of the advertising distribution system or may participate a public distribution network with other users. Users running private sub-networks may add these sub-networks instantly to the public network, allowing access to the greater, global advertiser pool should these users choose to play those public pool advertisements rather than seek, add and manage their own.

Within the public network a user may manage a subset of locations without affecting management of other locations participating in the public network. Any number of otherwise unaffiliated advertisers and retailer users may cooperate in a cohesive public network.

According to another embodiment of the present invention, digital signage companies may create an account which allows it to create a private library that does not participate in the system's public library. In this embodiment, the credit application and billing areas are hidden to the public. This allows a digital signage company to create its own advertising that does not participate in the system. When setting up locations in this embodiment, the digital signage company would only have access to the advertisements belonging to its digital signage company advertiser account.

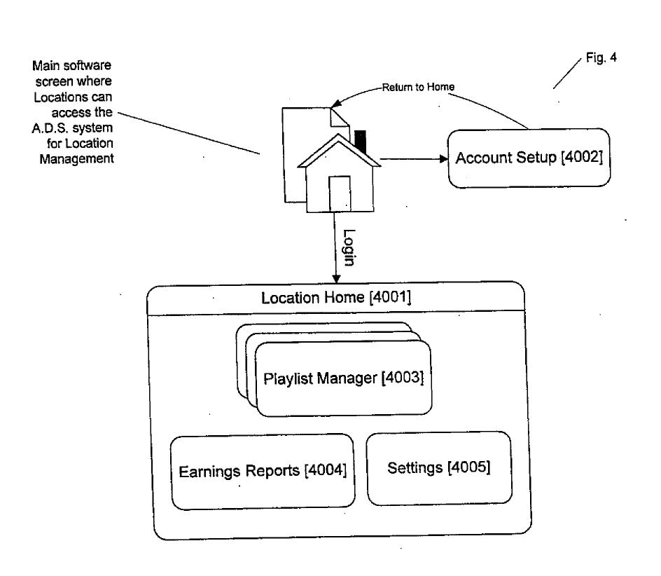

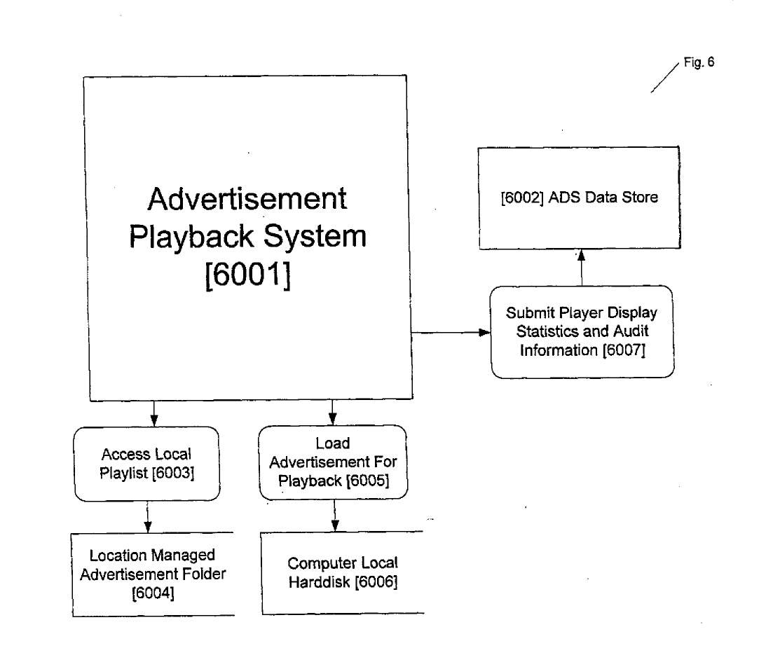

As shown in FIGS. 4 and 6, the location management console is another key component of the system of the present invention. In FIG. 6, a schematic is shown of a downloadable advertisement player. The player may be used to retrieve centrally stored, custom advertisement looping playlists. These playlists can be suggested promotional lists created by the advertiser or assembled by a location to support their retail activity.

The player provides the ability to preview individual advertisements or entire playlists within the player through retrieval of advertising media over the Internet. Drag and drop addition and removal of advertisements to playlists can be achieved through the player. another player function is automated creation of blended playlists through the selection of multiple campaigns which are trimmed proportionately and shuffled evenly to create a new playlist.

The player may also include a filtering system that allows for browsing of the system library for selections matching the location's demographics, advertisement category choices and advertising commission expectations.

A location management console is a component of the system by which playlists for any location can be accessed from any other location provided they are both owned by the same account holder. This is made possible by the central storage of location profiles.

Changes to location playlist profiles are saved centrally in the system so no backup is required at the remote locations. Location managers can accelerate the setup of additional locations by utilizing these existing playlists by choosing them from the server.

A playlist management system allows for the use of custom created playlists, suggest default playlists based on demographic compatibility or specially designed promotional playlists. Promotional playlists may be offered with various goals in mind including product liquidation, cross-selling or profit-margin focused selling. Advertisements may be replaced when the system detects advertisement display patterns inconsistent with a campaign's goals.

Advertisements that are removed due to the end of a campaign are removed from the playlist and replaced with the closest matching advertisement. Available advertisements are instantly made available as they become available due to demographic or campaign changes identified by the system averaging algorithm.

Automatically generated reporting includes player statistics on advertisement play times, exposures, duration and more. The system includes a feature to generate scheduled reports which can be automatically emailed to location managers.

Alerts may be generated by the system to notify location managers of advertisements that are due to expire within 14 days, or to notify them when advertisements are replaced due to adjustments to active campaigns.

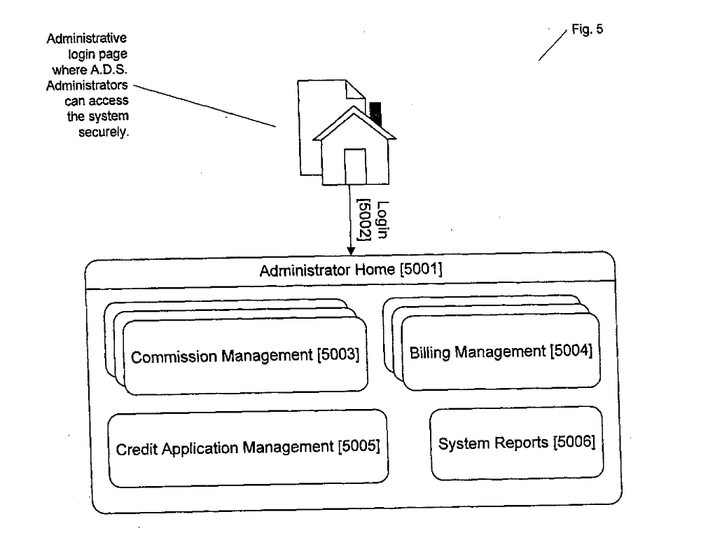

As depicted in FIG. 5, administrator features of the system include billing features which provide an online system for the review, editing and approval of automatically generated bills for advertisers' completed campaigns. The system can also function to review, edit and approve automatically generated commission payouts for locations.

The administrator features will include an alert system to notify administrators of the end of a campaign, or to warn administrators of errors, locations that have come offline, or campaigns which are off plan. There is also a reporting system to display detailed audit trails, statistical data and accounting information for both advertisers and locations. Additionally, statistical and accounting data from advertisers and locations may be exported and downloaded.

There are further provided specialized location player playback features, including an advertisement player with an onscreen toolbar with features specific to advertisement playlist management for a retail location, and support for hotkey access to common controls such as ‘ESC’ to leave full screen mode. A mouse-hide during advertisement playback feature is included. The player offers support of multiple media formats such as flash, mpeg, avi, and others for the advertisements and downloads them locally for enhanced performance and the ability to operate while offline. The location player has the ability to play the most current playlist automatically, even if the playlist is edited while the location player is running, and without requiring a restart of the location player.

The system includes an auditing support feature which undertakes automatic interval driven statistic submission of advertisement display activity to the system including IP address and location identification for tracking and security purposes.

The system permits monitoring for campaign changes that affect any current playlist. Automatic adjustment of playlists is made where the system indicates a change is necessary.

The location player may include automatic scheduled maintenance updates of the location player software with a system that allows for an alternative display while an update is in progress. Further, the location player has private library support for accessing a private advertiser library such as one maintained by a digital signage company. This allows the location player to browse only the digital signage company's advertisements while remaining completely separated from the public system library.

There are numerous advantages to advertisers offered by the present invention. These include: the uploading of advertisements to a distribution hub, access by advertisers in real time, and assignment by advertisers of a demographic target to an individual ad or a group of ads. Advertisers are provided with very good access to ad campaign information and statistics. Advertisers can check the popularity of their ad based on how many exposures an ad is generating in real time. Advertisers can request an audit which will give them a list of every location in the world currently playing a selected ad. Any advertisement currently running can be changed by the advertiser to update a product offering in real time to all screens.

Locations will benefit from an immediate revenue stream, Upon preparation of their playlist and uploading of their selected ad files, revenue may be generated. Locations may select advertisements for products in their store or other outlet which they wish to promote. Access to the system is available through any internet connection, enabling the location to go online to change a playlist at any time from anywhere.

It will be appreciated by those skilled in the art that other variations of the preferred embodiment may also be practised without departing from the scope of the invention.

What is claimed is:

1. A digital advertising network for the distribution of multimedia advertisements, comprising:
a server;
at least one administrator interface connected by a WAN to the server;
at least one location interface connected by a WAN to the server and to each of the at least one administrator interfaces; and
at least one advertiser interface connected by a WAN to the server, to each of the at least one administrator interfaces and to each of the at least one location interfaces;
wherein the distribution of multimedia advertisements at a selected location is fully controllable from the location interface of the selected location.

2. The digital advertising network of claim 1, wherein the server further comprises a mainframe computer having a storage component for storage of system data.

3. The digital advertising network of claim 1, wherein each administrator interface comprises:
commission management means managing location commissions;
billing management means for managing advertiser billings;
credit application management means for processing advertiser credit requests; and
system reporting means for generating system reports.

4. The digital advertising network of claim 1, wherein each location interface comprises:
playlist management means for managing advertising playlists;
earning reporting means for reporting location earnings; and
settings means for setting location parameters.

5. The digital advertising network of claim 1 wherein each advertiser interface comprises:
campaign management means for managing advertising campaigns;
advertising management means for managing advertisements;
billing means for processing billings;
credit application means for preparing credit applications; and
reporting means for generating advertiser reports.

6. A method of distributing advertisements to a plurality of locations in a digital advertising network, the method comprising the steps of:
a) each location identifying and inputting location demographic parameters;
b) identifying a digital advertising campaign budget;
c) identifying a digital advertising timeframe;
d) identifying the campaign demographic parameters of the digital advertising campaign;
e) identifying qualified locations by matching location demographic parameters to campaign demographic parameters;
f) each qualified location selecting advertisements which are consistent with the campaign demographic parameters;
g) generating a distribution schedule which is consistent with the campaign budget, campaign timeframe and available locations; and
h) distributing the digital advertising advertisements to the locations according to the distribution schedule.

7. The method of claim 6, further comprising the additional steps after step (h) of:
(i) modifying the location demographic parameters; and
(j) repeating steps (e) through (h).

8. The method of claim 6, further comprising the additional steps after step (h) of:
(k) modifying the digital advertising campaign budget; and
(l) repeating steps (g) and (h).

9. The method of claim 6, further comprising the additional steps after step (h) of:
(m) modifying the digital advertising campaign budget; and
(n) repeating steps (g) and (h).

10. The method of claim 6, further comprising the additional steps after step (h) of:
(o) modifying the selection of advertisements; and
(p) repeating steps (g) and (h).

11. A method of distributing advertisements to a plurality of locations in a digital advertising network, the method comprising the steps of:
a) identifying location demographic parameters;
b) identifying a digital advertising campaign budget;
c) identifying a digital advertising timeframe;
d) identifying the campaign demographic parameters of the digital advertising campaign;
e) identifying qualified locations by matching location demographic parameters to campaign demographic parameters;
f) generating a distribution schedule which is consistent with the campaign budget, campaign timeframe and available locations;
g) distributing the digital advertising advertisements to the locations according to the distribution schedule; and
h) providing compensation by advertisers to each location for each display of that advertiser's advertisement at that location.

12. The method of claim 11, further comprising the additional steps after step (h) of:
(i) modifying the location demographic parameters; and
(j) repeating steps (e) through (h).

13. The method of claim 11, further comprising the additional steps after step (h) of:
(k) modifying the digital advertising campaign budget; and
(l) repeating steps (g) and (h).

14. The method of claim 11, further comprising the additional steps after step (h) of:
(m) modifying the digital advertising campaign budget; and
(n) repeating steps (g) and (h).

15. The method of claim 11, further comprising the additional steps after step (h) of:
(o) modifying the selection of advertisements; and
(p) repeating steps (g) and (h).
